(19) United States
(12) Patent Application Publication
(10) Pub. No.: US 2004/0100639 A1
(43) Pub. Date: May 27, 2004

(54) Method and system for obtaining three-dimensional surface contours

(75) Inventors: Hsin-Yueh Sung, Taipei (TW); Li-Fen Tien, Hsinchu (TW); Fu-Shiang Yang, Hsinchu (TW); Chun-Yu Lin, Hsinchu (TW); Yan-Rung Lin, Hsinchu (TW)

Correspondence Address: QUINTERO LAW OFFICE, 1617 BROADWAY, 3RD FLOOR, SANTA MONICA, CA, 90404, US

(73) Assignee: Industrial Technology Research Institute

(21) Appl. No.: 10/716,821

(22) Filed: Nov. 19, 2003

(30) Foreign Application Priority Data
Nov. 22, 2002 (TW) 91134061

(51) Int. Cl. G01B 11/24

(52) U.S. Cl. 356/605

(57) ABSTRACT

A method and system for determining a three-dimensional surface profile of an object comprising a plurality of object points. First, a grating projector is provided to direct an incident beam of light having a pattern at the object. Then, a resultantly formed grating image of a line profile of the object is received and stored in a multi-line photoelectric image device. Next, the outputs of the grating projector and the multi-line photoelectric image device are taken together to form the phase shifter and the object is shifted opposite to a phase shifter. The above steps are repeated until all object points are imaged on the multi-line photoelectric image device. Finally, a phase of each object point is determined, each phase transformed and rectified to a height by an appropriate trigonometric algorithm for viewing on a display device.

### BACKGROUND OF THE INVENTION

1. Field of the Invention

The invention relates to the determination of the surface contours of objects and more particularly to an improved method and system for determining three-dimensional surface profiles of objects to increase measurement accuracy and save measurement time.

2. Description of the Related Art

Surface profile measurement by non-contact optical methods has been extensively studied because of its importance in fields such as automated manufacturing, component quality control, medicine, robotics, and solid modeling applications. In most of these methods a known periodic pattern, such as a grating, is projected on the surface to be measured and the image of the grating, resultantly formed by the surface, is analyzed to determine the profile. “Demodulation” of the resultantly formed grating by means of a matched reference grating results in the known Moire fringe patterns, which are easily interpretable as surface contours by a human observer, but are somewhat more complicated for computer analysis. (See, for example, D. M. Meadows, W. O. Johnson and J. B. Allen, Appl. Opt. 9, 942 (1970); H. Takasaki, Appl. Opt. 9, 1467 (1970); P. Benoit, E. Mathieu, J. Hormiere and A. Thomas, Nouv. Rev. Opt. 6, 67 (1975); T. Yatagai, M. Idesawa and S. Saito, Proc. Soc. Photo-Opt. Instrum. Eng. 361, 81 (1982)). Improvements to the Moire method, aimed at increasing accuracy and automating the measurements have been based, for example, on phase modulation. (See G. Indebetouw, Appl. Opt. 17, 2930 (1978), D. T. Moore and B. E. Truax, Appl. Opt. 18, 91 (1979).

An alternative approach to Moire is by analysis of the resultantly formed grating itself without the use of a physical or virtual reference grating. Direct methods based on geometrical analysis of the resultantly formed grating requiring fringe peak determination are computationally complex, slow, and result in low accuracy. Another direct method, based on the use of a Fast Fourier Transform analysis of the resultantly formed grating, has been demonstrated to be more suitable for automated profilometry (see, for example, M. Takeda and K. Mutoh, Appl. Opt. 22, 3977 (1983)). Limitations on measurement of steep object slopes and step discontinuities, demands for high resolution imaging systems and powerful computing capability are some of the disadvantages of the Fast Fourier Transform method.

To overcome the drawbacks, use of a phase shift interferometry is provided to find a phase distribution. [See, for example, J. H. Bruning, D. R. Herriott, J. E. Gallagher, D. P. Rosenfeld, A. D. White and D. J. Brangaccio, Appl. Opt. 13, 2696 (1974); J. C. Wyant, Appl. Opt. 14, 2622 (1975); Robinson, David W. and Reid, Graeme T., “Interferogram Analysis, Digital Fringe Pattern Measurement Techniques”, Institute of Physics Publishing, Ltd. 1993, pp. 94-193 for background.] Although, the phase shift method can increase measurement accuracy to 100˜1000 times, one point is required a plurality of striped interferometry images (at least three, usually four, five or more) to rebuild a phase distribution because of the height difference in the object surface. Thus, it takes a long time to measure one object. The method is suitable only for laboratory use, and cannot be efficiently employed in industry with high efficiency.

M. Halious et al. provide an apparatus and method for obtaining three-dimensional surface contours in U.S. Pat. No. 4,641,972 and 4,657,394. FIG. 1 is a block diagram illustrating an apparatus for obtaining three-dimensional surface contours as disclosed in U.S. Pat. No. 4,657,394. A sinusoidal grating projection system and phase shifter 10 direct an incident beam of light having a sinusoidally varying intensity pattern at a three-dimensional object 11. The sinusoidal grating projection system and phase shifter 10 modulate the phase of the sinusoidal intensity pattern of the incident beam. The linear array camera 13 receives a resultantly formed grating image of a line profile of the object. Information from the linear array camera 13 is digitized by an analog-to-digital converter 14, and the resultant digital signals are coupled to a processor 16. The processor 16 stores the resultant digital signals.

A scanning device 12 implements rotational increments of the object 11 with respect to the sinusoidal grating projection system and phase shifter 10 so that the linear array camera 13 receives resultantly formed grating images of different line profiles of the object 11. For object points on such line profiles of the surface of the object 11, the processor 16 determines the distance at each such object point with respect to a reference line. After the distance is appropriately transformed and corrected, the processed information can be viewed on a display device 18.

In the apparatus, phase shift of the sinusoidal pattern is achieved by a quarter wave plate and a rotational linear polarization plate. Limitations of the method are that the phase modulation is not fast enough, influencing the linearity of the phase shifter, and the apparatus can only be used with a laser light source, being unsuited for use with typical white light projection systems imaging a raster on an interface of the object.

The method combining fringe projection and phase shift interferometery has high measurement accuracy, but difficulty arises when performing a trace of relative motion between the sinusoidal pattern and the object in any kind of projection system. Furthermore, such a system requires much time to measure one object (multiple incident beams of light of different phases must be projected on every object point). Thus, the system cannot be used efficiently in industry.

SUMMARY OF THE INVENTION

It is an object of the present invention to provide an improved method and system for determining three-dimensional surface profiles of objects to increase measurement accuracy and save measurement time. Using a multi-line photoelectric image device, such as multi-line CCD camera, a typical scan method of the multi-line photoelectric image device, and a corresponding algorithm, the present method can achieve the result equal to the typical method combining fringe projection and phase shift. With higher measurement accuracy and shorter measurement time, the present invention is effectively used in industry. The present invention thus provides a method and system for determining three-dimensional surface profiles of objects. The major difference between the present invention and the prior art is, in conventional systems, the sinusoidal grating projection system, phase shifter 10, and the linear array camera 13 shown in FIG. 1 perform two separate operations, but in the present invention scan, image and shift results of the projected sinusoidally varying intensity pattern are taken as one. The linear sensor avoids the errors in the pattern. As well, the present method is suited for use with all projection systems, such as a typical white light projection system or a laser projection system.

Selectively, the method for determining three-dimensional surface profiles of objects further comprises rectifying optical vigetting and uniformly rectifying different pixel responses to obtain the same responses of images received by the multi-line photoelectric image device when a plurality of incident beams of light with different phases project on one object point.

### DESCRIPTION OF THE DRAWINGS

The present invention is herein described by way of exemplary embodiments, but not limitations, illustrated in the accompanying drawings in which like references denote similar elements, and in which:

FIG. 1 is a block diagram illustrating an apparatus for obtaining three-dimensional surface contours shown in U.S. Pat. No. 4,657,394;

FIG. 2 is a flowchart illustrating a method for determining a three-dimensional surface profile of an object according to an embodiment of the invention;

FIG. 3 is a block diagram illustrating a system for determining a three-dimensional surface profile of an object according to the embodiment of the invention;

FIG. 4a is a diagram illustrating imaging on an object point with a first phase using the method shown in FIG. 2.

FIG. 4b is a diagram illustrating imaging on an object point with a second phase using the method shown in FIG. 2.

FIG. 4-c is a diagram illustrating imaging on an object point with a third phase using the method shown in FIG. 2.

FIG. 5 is a diagram illustrating an example of projecting stripe patterns on an object with spherical surface.

FIG. 6 shows three frame received by the CCD camera when the phase shifter scans according to the embodiment of the present invention.

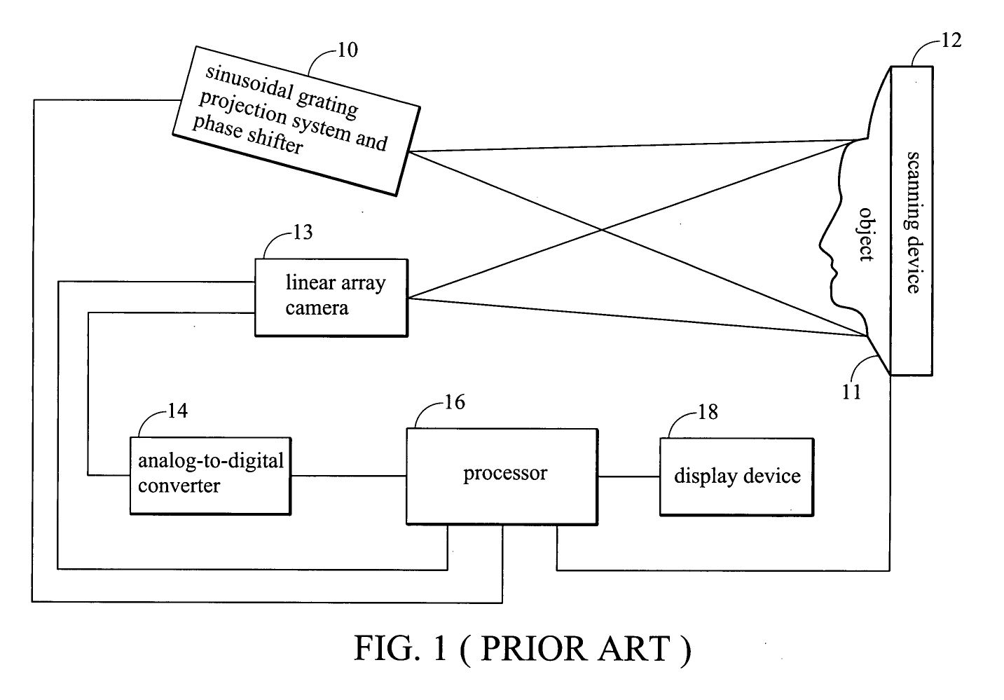

### DETAILED DESCRIPTION OF THE INVENTION

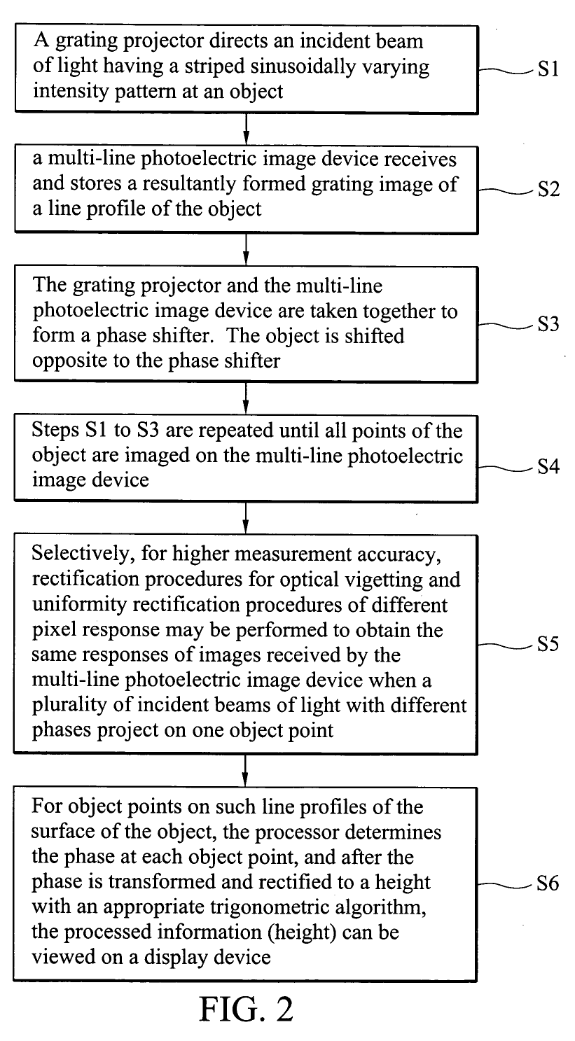

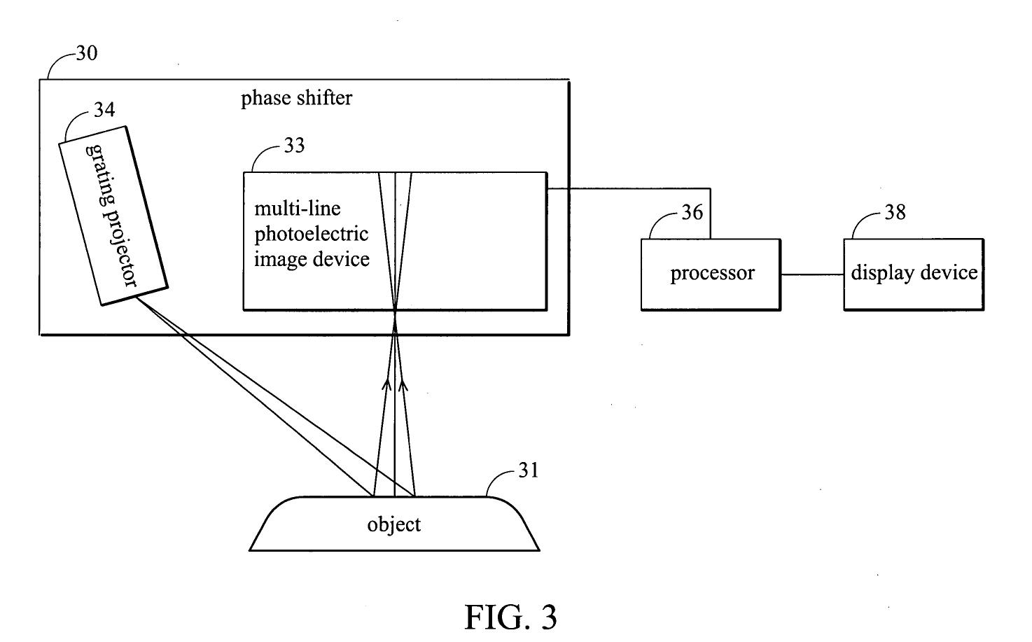

FIGS. 2 and 3 are respectively a flowchart and block diagram illustrating a method and system for determining a three-dimensional surface profile of an object according to an embodiment of the invention. A grating projector 34 directs an incident beam of light having a striped sinusoidally varying intensity pattern at an object 31 (S1). Then, a multi-line photoelectric image device 33 receives and stores a resultantly formed grating image of a line profile of the object (S2). The grating projector 34 and the multi-line photoelectric image device 33 are taken together to form a phase shifter 30. The object 31 is shifted opposite to the phase shifter 30 (S3). Steps S1 to S3 are repeated until all points of the object 31 are imaged on the multi-line photoelectric image device 33 (S4).

Selectively, for higher measurement accuracy, rectification procedures for optical vigetting and uniformity rectification procedures of different pixel response may be performed to obtain the same responses of images received by the multi-line photoelectric image device when a plurality of incident beams of light with different phases project on one object point (S5).

For object points on such line profiles of the surface of the object 31, the processor 36 determines the phase at each object point. After the phase is transformed and rectified to a height with an appropriate trigonometric algorithm, the processed information (height) can be viewed on a display device 38 (S6).

The multi-line photoelectric image device 33 may be arranged by a plurality of CCD elements, CMOSs, photo diodes or other elements with high sensitivity. The multi-line photoelectric image device 33 may comprise a plurality of photoelectric elements arranged in an array structure or a structure of multiple lines.

The grating projector 34 may be replaced with another directing a sinusoidally varying intensity pattern at the object or with a Moire pattern.

The system for obtaining three-dimensional surface contours may comprise two or more grating projectors, with the relative position between at least one of which and the multi-line photoelectric image device fixed.

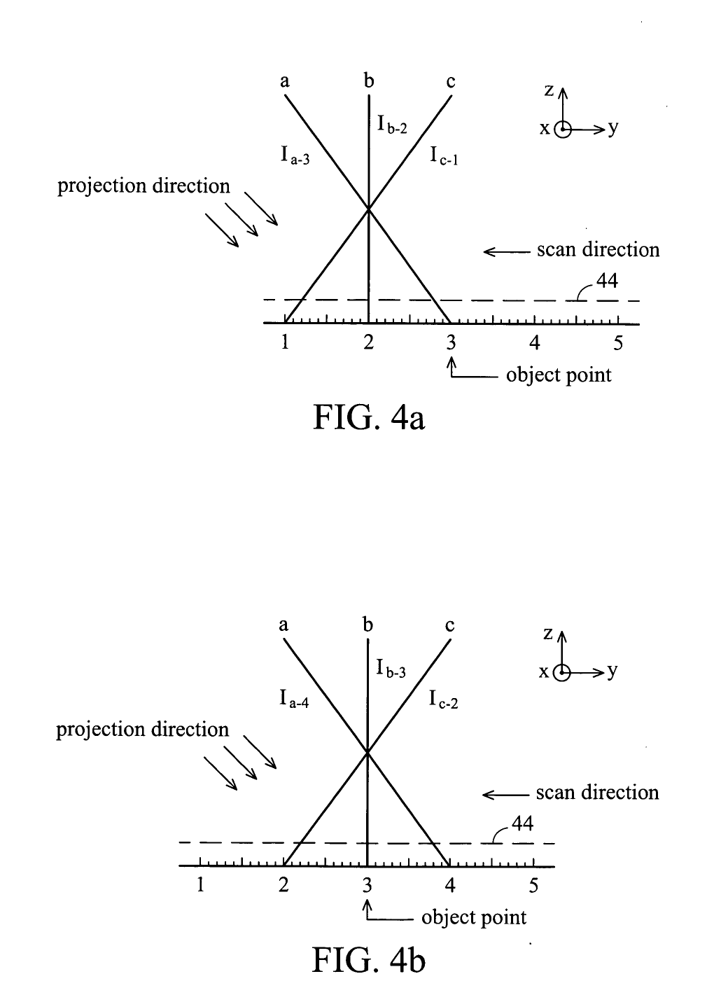

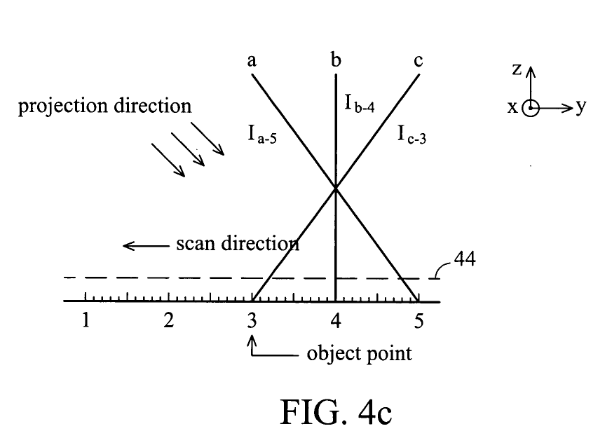

For detailed illustration, a special system with the following parameters is used as an example (referring FIG. 3 and FIG. 4 at the same time). A CCD camera used in the special system is an example of the multi-line photoelectric image device. A direction of three lines in the CCD camera is defined as an X axis. A scan direction is defined as a Y axis.

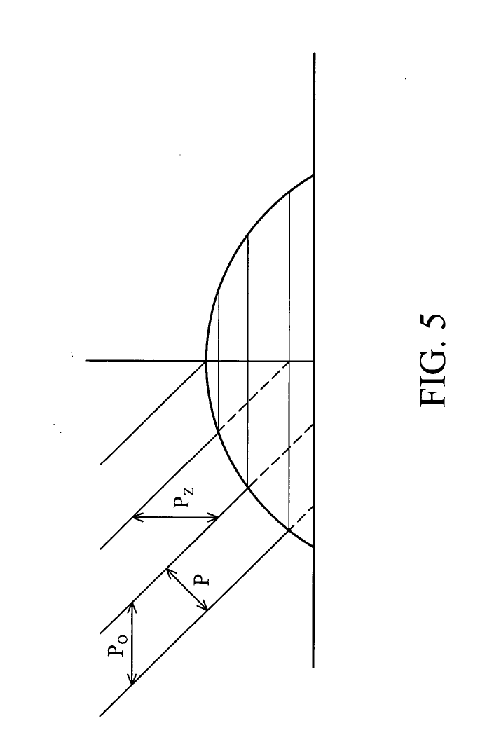

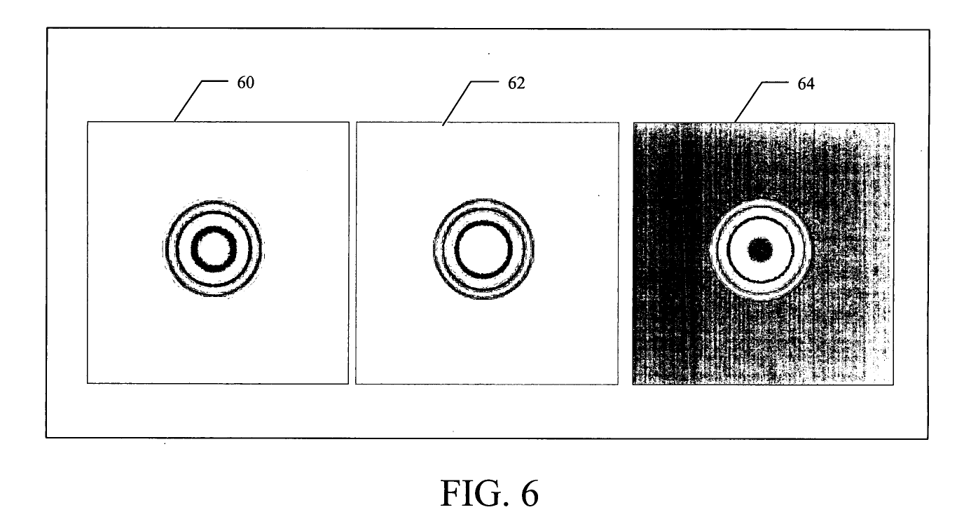

FIG. 4a˜4c are diagrams illustrating imaging on an object point three times using the method shown in FIG. 2. Using the system shown in FIG. 3, the grating projector directs an incident beam of light having a striped sinusoidally varying intensity pattern at the object. The grating projector and the three-line CCD camera are taken together to form the phase shifter. The object is shifted opposite to the phase shifter. The scan method is the same as that using in a typical single line CCD camera. Thus, three frames are received by the CCD camera at the same time. If the object has a spherical surface as shown in FIG. 5, the frames receives by the CCD camera are shown in FIG. 6. In FIG. 5, P is the period of the striped sinusoidally varying intensity pattern. Pₒ is the period of the striped sinusoidally varying intensity pattern in direction Y. P_{z} is the period of the striped sinusoidally varying intensity pattern in directionz.

For the first imaging of the object point 3; as shown in FIG. 4a, an image Iₐ₋₃ of the object point 3 is received by the CCD line a. An image I_{b-2} of the object point 2.5 is received by CCD line b. An image I_{c-1} of the object point 1.5 is received by CCD line c.

For the second imaging of the object point 3; as shown in FIG. 4b, an image Iₐ₋₄ of the object point 4 is received by the CCD line a. An image I_{b-3} of the object point 3 is received by CCD line b. An image I_{c-2} of the object point 2 is received by CCD line c.

For the third imaging of the object point 3; as shown in FIG. 4c, an image Iₐ₋₅ of the object point 5 is received by the CCD line a. An image I_{b-4} of the object point 4 is received by CCD line b. An image I_{c-3} of the object point 3 is received by CCD line c.

The phase of the object point 3 is

$$Φ ( x , y ) = {tan}^{- 1} ( \frac{{I}_{2} - {I}_{3}}{{I}_{1} - {I}_{3}} )$$

where I₂=Iₐ₋₃, I₁=_{b-3},

$${I}_{3} = \frac{1}{2} ( {I}_{b - 3} + {I}_{c - 3} ) ,$$

Iₙ=I₀[1+γ cos [Φ(x,y)+δ]]

I₁→δ=0°, I₂→δ=−90°, I₃→the intensity average of the frmes with δ=0° and 180° The height of the object point 3 is

$$h ( x , y ) = {P}_{z} \frac{Φ ( x , y )}{2 π}$$

wherein Pz is _the_fringe period in z direction

Using the above method, phases and heights of all object points can be obtained.

In the present embodiment, the object is shifted along the Y axis. _The CCD camera and the grating projector are fixed. For −90°, 0°, 180° phase shifter, the lens amplification, the period of the grating projector, and the interval between two nearest lines of the CCD camera can be adjusted.

Selectively, for higher measurement accuracy, rectification procedures for optical vigetting and pixel response uniformity may be performed to obtain the same responses of images received by the CCD camera when three incident beams of light with different phases project on one object point.

The method and system for determining three-dimensional surface profiles of objects provided by the present invention increases measurement accuracy and saves measurement time. Using a multi-line photoelectric image device, such as multi-line CCD camera, a typical scan method of the multi-line photoelectric image device, and a corresponding algorithm, the present method achieves results equal to the typical method combining fringe projection and phase shift. Further, its high measurement accuracy and short measurement time suit it particularly well to use in industry.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for determining a three-dimensional surface profile of an object comprising a plurality of object points, the method comprising:
(a) providing a grating projector to direct an incident beam of light having a pattern at the object;
(b) receipt and storage of a resultantly formed grating image of a line profile of the object by a multi-line photoelectric image device;
(c) shifting the object opposite to a phase shifter, wherein the grating projector and the multi-line photoelectric image device are taken together to form the phase shifter;
(d) repeating steps (a) to (c) until all object points are imaged on the multi-line photoelectric image device; and
(e) determining a phase of each object point, and transforming and rectifying the phase to a height by an appropriate trigonometric algorithm to be viewed on a display device.

2. The method of claim 1, further comprising, before step (e), rectifying optical vigetting and uniformly rectifying different pixel responses for the multi-line photoelectric image device.

3. The method of claim 1 wherein shifting the object opposite to a phase shifter is a relative motion between the object and the phase shifter.

4. The method of claim 1 wherein the pattern is a striped sinusoidally varying intensity pattern, a sinusoidally varying intensity pattern, or a pattern made by the Moire method.

5. The method of claim 1 wherein the multi-line photoelectric image device is arranged by a plurality of CCD elements, CMOSs or photo diodes.

6. The method of claim 1 wherein the multi-line photoelectric image device comprises a plurality of photoelectric elements arranged in an array structure.

7. A system for determining a three-dimensional surface profile of an object comprising a plurality of object points, the system comprising:
a phase shifter comprising:
at least one grating projector to direct an incident beam of light having a pattern at the object; and
a multi-line photoelectric image device;
wherein the relative position between one of the grating projectors and the multi-line photoelectric image device must be fixed, and the object is shifted opposite to the phase shifter to obtain a plurality of scan images; and
a processor for determining a plurality of phases according to the scan images, and transforming the phases to the three-dimensional surface profile of the object by an appropriate trigonometric algorithm.

8. The system of claim 8, further comprising a display coupled to the processor for displaying the three-dimensional surface profile of the object.

9. The system of claim 8 wherein, for the multi-line photoelectric image device, rectification procedures for optical vigetting and uniformity for different pixel response are performed in the processor.

10. The method of claim 8 wherein shifting the object opposite to a phase shifter is a relative motion between the object and the phase shifter.

11. The method of claim 8 wherein the pattern is a striped sinusoidally varying intensity pattern, a sinusoidally varying intensity pattern, or a pattern made by the Moire method.

12. The method of claim 8 wherein the multi-line photoelectric image device is arranged by a plurality of CCD elements, CMOSs or photo diodes.

13. The system of claim 8 wherein the multi-line photoelectric image device comprises a plurality of photoelectric elements arranged in an array structure.
